(19) United States
(12) Patent Application Publication
(10) Pub. No.: US 2009/0070003 A1
(43) Pub. Date: Mar. 12, 2009

(54) DEVICE FOR CONTROLLING THE OPERATING STATE OF A CATALYTIC CONVERTER OF AN EXHAUST LINE PERTAINING TO AN INTERNAL COMBUSTION ENGINE, AND ENGINE COMPRISING ONE SUCH DEVICE

(75) Inventors: Benoit Thuault, Morsang Sur Orges (FR); Helene Biales, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT s.a.s., Boulogne Billancourt (FR)

(21) Appl. No.: 11/718,475

(22) PCT Filed: Oct. 25, 2005
(86) PCT No.: PCT/FR2005/050899

§ 371 Date: Jan. 28, 2008

(30) Foreign Application Priority Data
Nov. 2, 2004 (FR) 0411640

(51) Int. Cl. F02D 41/04; F01N 3/20; F02D 41/30

(52) U.S. Cl. 701/103; 60/286; 60/285; 123/676

(57) ABSTRACT

A device for controlling an operating state of a catalytic converter of an exhaust line pertaining to an internal combustion engine. The device determines the temperature upstream of the catalytic converter, adds fuel to the exhaust line of the engine at the moment at which the temperature of the exhaust gas upstream of the catalytic converter corresponds to the ignition temperature of a catalytic converter with a normal operation, and controls the quantity of heat emitted by the reaction generated in the catalytic converter as a result of the addition of fuel. The addition device includes a dedicated fuel supply system arranged in the exhaust line of the engine upstream of the catalytic converter to be controlled.

### TECHNICAL FIELD OF THE INVENTION

The present invention relates in general to the treatment of exhaust gases of an internal combustion engine, for example, of a motor vehicle and, in particular, an internal combustion engine operating with a lean mixture, particularly a diesel or gasoline engine.

The invention relates more particularly to a device for controlling the operating status of a catalytic converter installed in an exhaust line of an internal combustion engine, designed for controlling said catalytic converter and always capable of appropriately performing its function.

It also relates to an internal combustion engine for a motor vehicle comprising an exhaust line equipped with at least one catalytic converter and one such device for controlling the operating status of said converter.

### TECHNOLOGICAL BACKGROUND

Internal combustion engines produce exhaust gases which contain polluting substances, such as nitrogen oxides (NOx), unburnt hydrocarbons (HC), carbon monoxide (CO), which must be treated before being released into the atmosphere.

Thus, motor vehicles are often provided with a catalytic converter placed in the engine exhaust line, for oxidizing the reducing substances, which are carbon monoxide (CO) and unburnt hydrocarbons (HC).

Such a catalytic converter may be an oxidation catalyst, a catalyzed particulate filter, or a nitrogen oxide (NOx) trap.

Some motor vehicles comprise a plurality of different catalytic converters placed in series in their exhaust line.

In order to control the satisfactory operation of at least one catalytic converter, the motor vehicles are also generally provided with a device for controlling the operating status of the catalytic converter, capable on the one hand of controlling the satisfactory operation of the converter and, on the other hand, of indicating any malfunction to the driver.

Among the causes of malfunctions, the aging of the catalytic converter causes a drop in the unburnt hydrocarbon and carbon monoxide conversion efficiency, due among other causes to a decrease in the active pollutant treatment surface area in the converter, giving rise to an increase in the thermal ignition temperature of the oxidation reactions generated therein, that is, the temperature above which the conversion efficiency is equal to or higher than 50%.

To control the satisfactory operation of a catalytic converter, document FR 2 833 994, belonging to the applicant, describes a device comprising means for determining the temperature upstream of the catalytic converter, means for injecting fuel into one or more cylinders of the engine during their expansion phase at the moment when the exhaust gas temperature upstream of the catalytic converter corresponds to the ignition temperature of a catalytic converter having a normal operation, and means for controlling the quantity of heat emitted by the reaction generated in the catalytic converter as a result of this fuel post-injection.

Such a control device, while relatively efficient, nevertheless has many drawbacks.

Firstly, it uses a fuel post-injection into an engine cylinder in an expansion phase, which is liable to cause a dilution of the fuel in the engine oil when the fuel jets touch the walls of the cylinder barrels as the piston is lowered, which is undesirable.

Furthermore, the fuel post-injection into an engine cylinder causes the production of a certain quantity of CH₄ not treated by the catalytic converter. This gives rise to serious penalties in terms of unburnt hydrocarbons during a homologation cycle.

Finally, because of the fact that it uses a post-injection into the engine cylinders, such a control device only serves to control the operation of the catalytic converter located nearest to the outlet of the combustion chamber. Thus, when the engine comprises at least two catalytic converters placed in series in the exhaust line, the second catalytic converter, further from the combustion chamber, cannot be controlled by such a control device.

### OBJECT OF THE INVENTION

In order to remedy the above drawbacks, the present invention proposes a device for controlling the operating status of a catalytic converter of an exhaust line of an internal combustion engine comprising means for determining the temperature upstream of the catalytic converter, means for adding fuel to the engine exhaust line at the moment when the exhaust gas temperature upstream of the catalytic converter corresponds to the ignition temperature of a catalytic converter having normal operation, and means for controlling the quantity of heat emitted by the reaction generated in the catalytic converter as a result of said fuel addition, characterized in that said addition means comprise a dedicated fuel feed system placed in the engine exhaust line upstream of the catalytic converter to be controlled.

Other nonlimiting and advantageous features of the control device according to the invention are the following:
the dedicated fuel feed system is an injection system;
the dedicated fuel feed system is a vaporization system;
a specific system is provided for injecting fuel into at least one engine cylinder to raise the exhaust gas temperature upstream of the catalytic converter to said ignition temperature thereof regardless of the motor vehicle running conditions, said specific fuel injection system being coupled with said dedicated fuel feed system;
means are provided for feeding fuel directly from the motor vehicle fuel tank to said dedicated feed system;
the means for determining the gas temperature upstream of the catalytic converter comprise means for measuring said gas temperature;
the means for determining the gas temperature upstream of the catalytic converter comprise means for measuring operating parameters of the engine and/or the catalytic converter and a thermal model of the exhaust gases suitable for determining the gas temperature upstream of the catalytic converter as a function of operating parameters of the engine and/or the catalytic converter;
the means for controlling the quantity of heat emitted by the reaction generated in the catalytic converter comprise means for measuring the exhaust gas temperature downstream of said converter and means for comparing the gas temperature downstream of the converter with a threshold value for detecting a malfunction; and
it comprises a computer for controlling the operation of the engine and for controlling the operation of the catalytic converter, said computer comprising said comparison means and storage means wherein are stored a set of threshold values each associated with one of the operating parameters of the engine and/or the catalytic converter and a set of values of the thermal ignition temperature of the catalytic converter as a function of the exhaust gas flow rate in said converter, the threshold value supplied to the comparison means being extracted from the storage means according to the measured operating parameters.

The invention further relates to an internal combustion engine for motor vehicle comprising an exhaust line equipped with at least one catalytic converter and a device for controlling the operating status of said catalytic converter as defined above.

### DETAILED DESCRIPTION OF AN EXEMPLARY EMBODIMENT

The description that follows with regard to the drawings appended hereto provided as nonlimiting examples, will clearly show what the invention comprises and how it can be implemented.

In the drawings appended hereto:

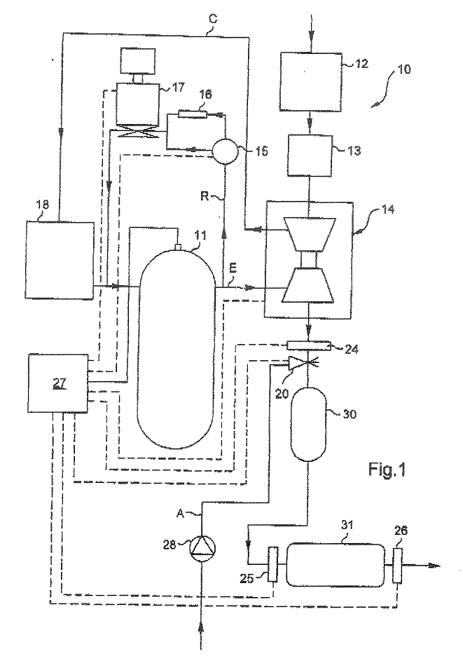

FIG. 1 is a schematic view of a first embodiment of an internal combustion engine comprising, in its exhaust line, a catalytic converter associated with a control device according to the invention;

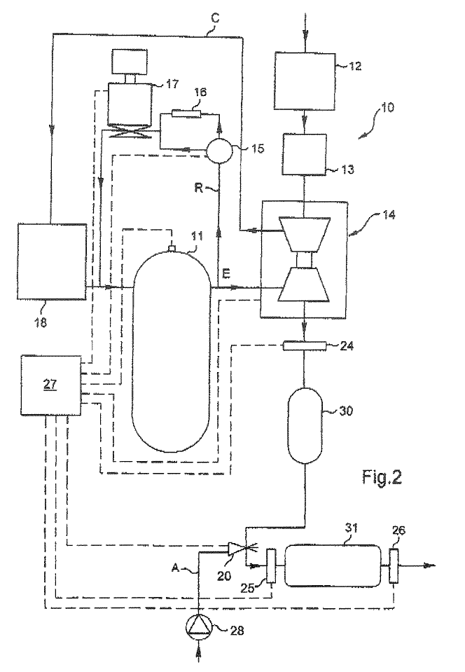

FIG. 2 is a schematic view of a second embodiment of an internal combustion engine comprising, in its exhaust line, a catalytic converter associated with a control device according to the invention;

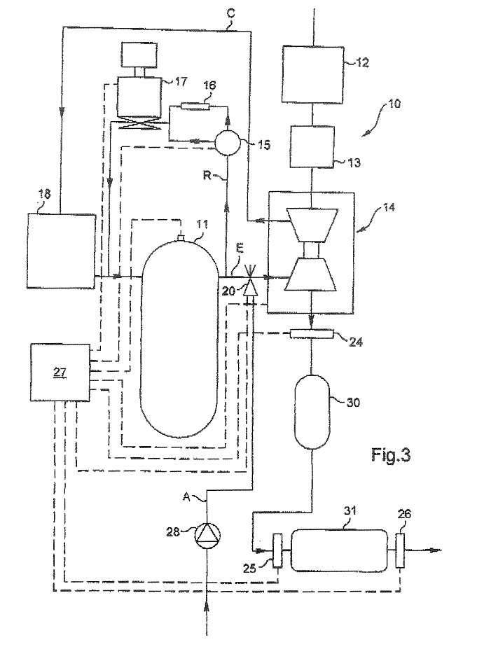

FIG. 3 is a schematic view of a third embodiment of an internal combustion engine comprising, in its exhaust line, a catalytic converter associated with a control device according to the invention;

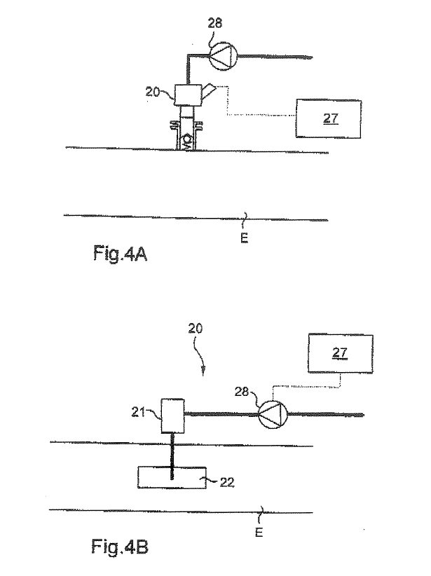

FIG. 4A is a schematic view of a first embodiment of the dedicated feed system of the control device according to the invention;

FIG. 4B is a schematic view of a second embodiment of the dedicated feed system of the control device according to the invention;

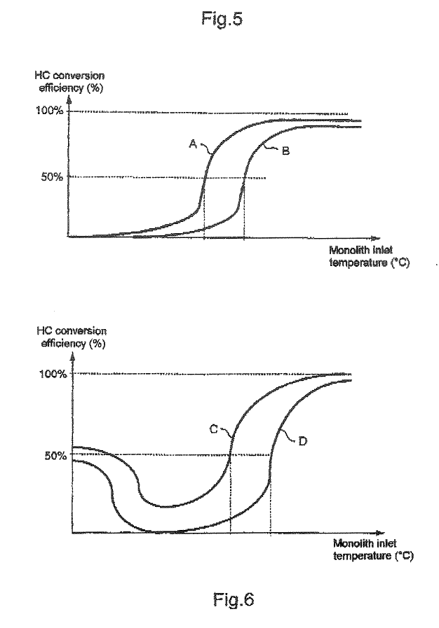

FIG. 5 shows curves illustrating the variation in the carbon monoxide CO conversion efficiency as a function of the converter inlet temperature, respectively for a new converter and for an old converter;

FIG. 6 shows curves illustrating the variation in the unburnt hydrocarbon HC conversion efficiency as a function of the converter inlet temperature, respectively for a new converter and for an old converter;

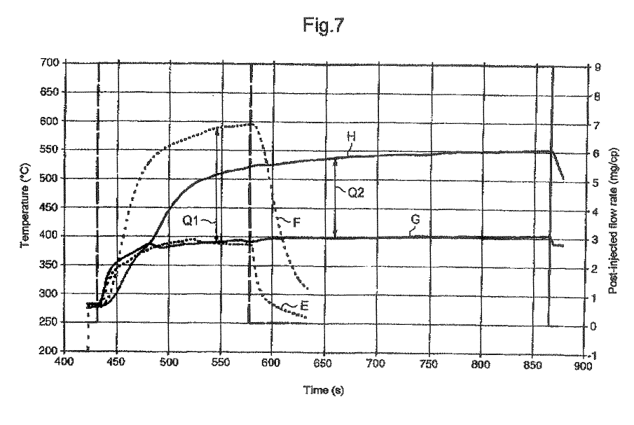

FIG. 7 shows curves illustrating the method implemented by the control device according to the invention to control the operating status of a catalytic converter of an internal combustion engine; and

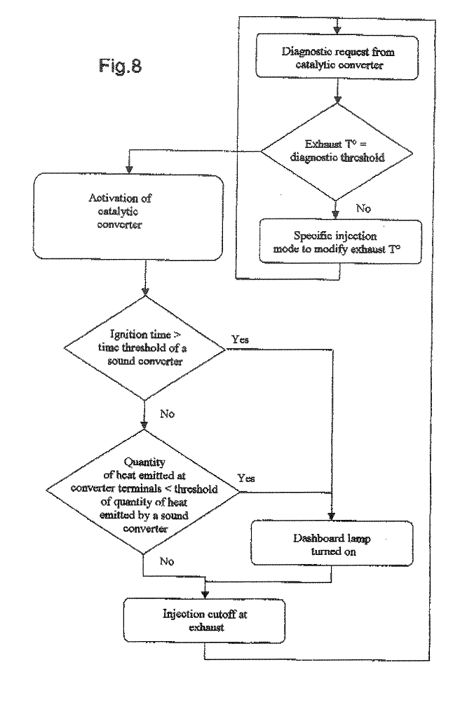

FIG. 8 is an operating algorithm of the control device according to the invention.

Firstly, it should be noted that from one figure to the next, identical or similar elements of the various embodiments of the invention are, whenever possible, denoted by the same references and are not described every time.

In FIGS. 1 to 3, the general structure of three alternatives of an internal combustion engine 10 are shown schematically, here a diesel engine of a motor vehicle.

This engine 10 comprises a combustion chamber 11 provided with cylinders. The cylinders of the combustion chamber 11 are supplied with cooling air by a cooler 18 associated with an intake manifold (not shown), itself supplied by a line C provided at the inlet with an air filter 12 followed by a flowmeter 13 and a turbocharger 14 for turbocharging the engine with air.

An exhaust manifold (not shown) recovers the exhaust gases issuing from the combustion and removes them to the exterior through an exhaust line E via the turbocharger 14.

An exhaust gas recirculation circuit R recovers part of the exhaust gases and reinjects them into the intake manifold in order to limit the quantity of nitrogen oxides produced by combustion, while preventing the formation of smoke in the exhaust gases.

As shown more particularly in FIGS. 1 to 3, the recirculation circuit R essentially comprises a valve 17 for adjusting the recirculated exhaust gas flow preceded by a cooler 16 supplied by a bypass 15.

As to the exhaust line E, this comprises two catalytic converters in series, that is for example, a catalyst 30 followed by a particulate filter or an NOx trap 31.

Obviously, the particulate filter or the NOx trap can precede the catalyst.

The catalyst 30 essentially performs the post-treatment of the exhaust gases by oxidizing the reducing compounds, which are carbon monoxide (CO) and burnt hydrocarbons (HC). The particulate filter or the NOx trap 31 performs the post-treatment of the particulates and NOx.

The catalyst 30 has a conventional structure within the scope of a person skilled in the art and is not described in detail here.

It essentially has a monolithic structure and is provided with channels impregnated with a catalytic phase, such as a precious metal, and having a large contact area with the exhaust gases.

It should also be noted that the monolith forming part of the catalyst 30 is integrated here with the particulate filter or with the NOx trap 31, to produce a coupling between the post-treatment of the exhaust gases by the oxidation of carbon monoxide and unburnt hydrocarbons (HC) with the post-treatment of particulates and NOx.

Finally, the engine 10 is associated with an onboard computer 27 which essentially controls the operation of the engine 10, particularly the adjustment of its operating parameters, and controls the operation of at least one of the converters 30, 31.

To control the operation of the engine 10, the computer 27 is connected to the main functional components of the engine, these connections being indicated by dotted lines.

To control the satisfactory operation of the catalytic converter concerned 30, 31, the computer 27 comprises storage means in which a set of data obtained by prior learning are stored, corresponding in particular to threshold values for detecting a malfunction, and also, if applicable, values of the temperature upstream of the catalytic converter to be controlled as a function of the downstream temperatures and software means for controlling the quantity of heat emitted by the chemical reaction generated by the post-injection in the catalytic converter by comparison with threshold values.

More particularly, the engine 10 comprises, as a device for controlling the operating status of one of the converters 30, 31, means 24, 25 for determining the temperature upstream of the corresponding catalytic converter 30, 31, means for adding fuel to the engine exhaust line E at the moment when the exhaust gas temperature upstream of the catalytic converter 30, 31 corresponds to the ignition temperature of a converter having normal operation and means 25, 26 for controlling the quantity of heat emitted by the reaction generated in the catalytic converter 30, 31 as a result of this fuel addition.

According to an essential feature of this control device, said addition means comprise a dedicated fuel feed system 20 placed downstream of the combustion chamber 11, in the exhaust line E of the engine 10, upstream of the catalytic converter 30, 31 to be controlled.

According to the example shown in FIG. 1, this dedicated feed system 20 is placed just upstream of the catalyst 30 to be controlled.

According to the example shown in FIG. 2, this dedicated feed system 20 is placed just upstream of the particulate filter or of the NOx trap 31 to be controlled.

According to the example shown in FIG. 3, this dedicated feed system 20 is placed upstream of the turbocharger 14 in order to control the catalyst 30.

The dedicated teed system 20 is connected to the computer 27, by which it is controlled.

Preferably, means are provided to feed fuel directly from the fuel tank of the motor vehicle to said dedicated feed system 20. These means comprise a pump 28 which sends fuel via a line A to the dedicated feed system 20.

According to one embodiment of the control device shown more particularly in FIG. 4A, the dedicated fuel feed system is an injection system 20 directly controlled by the computer 27.

According to another embodiment of the control device shown in FIG. 4B, the dedicated fuel feed system is a vaporization system 20 which comprises a vaporization chamber 22 immersed in the exhaust line E, this vaporization chamber 22 being connected to a fuel heating system 21 supplied by said pump 28 controlled by the computer 27.

Furthermore, according to the example shown in FIGS. 1 to 3, the means for determining the gas temperature upstream of the catalytic converter 30, 31 concerned comprise means for measuring said gas temperature.

Here, a sensor 24 is provided for measuring the exhaust gas temperature upstream of the converter 30, a sensor 25 for measuring the exhaust gas temperature downstream of the converter 30 and upstream of the converter 31, and a sensor 26 for measuring the exhaust gas temperature downstream of the converter 31.

The sensors 24, 25, 26 are connected to the computer 27.

It may be noted that the temperature sensor 24 is an optional element, because the temperature upstream of the converter 30 can be estimated either using a mathematical model and operating parameters of the engine and/or catalytic converter concerned, or from the temperature downstream of the converter concerned outside the post-injection phase.

The temperature measurements supplied by the sensors 24, 25, 26 are processed by the computation means of the computer 27 in order to determine the rise in the ignition temperature of the converter 30, 31 controlled to detect a drop in efficiency resulting from the conversion of the unburnt hydrocarbons (HC) and the carbon monoxide (CO).

In fact, with reference to FIG. 5, which shows the variation in CO conversion efficiency of the catalytic converter 30, 31 controlled as a function of the monolith inlet temperature, for a new converter (curve A) and for an old converter (curve B), it is found that the aging of a converter is accompanied by a relatively large increase in the ignition temperature of the converter, that is, of the temperature above which the conversion efficiency is equal to 50%.

Similarly, with reference to FIG. 6, which shows the variation in unburnt hydrocarbon HC conversion efficiency as a function of the monolith inlet temperature, respectively for a new converter (curve C) and an old converter (curve D), it is also found that the aging of the converter is accompanied by a relatively large increase in the ignition temperature of the converter.

However, at high temperature, the drop in conversion efficiency is negligible.

Thus to control the satisfactory operation of a converter 30, 31, the computer controls the ignition temperature of the converter to be controlled and/or controls, for an operating temperature corresponding to the ignition temperature of a sound converter, the quantity of heat emitted by the chemical oxidation reaction implemented in the converter.

The means for controlling the quantity of heat emitted by the reaction generated in the catalytic converter 30, 31 comprise means for measuring the exhaust gas temperature downstream of said converter, here the sensors 25, 26 and comparison means provided in the computer 27 for comparing the gas temperature downstream of the catalytic converter concerned with a threshold value for detecting a malfunction.

Furthermore, preferably, according to the invention, a specific system (not shown) is provided for injecting fuel into at least one engine cylinder to raise the exhaust gas temperature upstream of the catalytic converter to said ignition temperature thereof, regardless of the motor vehicle running conditions, this specific fuel injection system being coupled to said dedicated fuel feed system 20.

With reference more particularly to FIGS. 7 and 8, we shall now describe the method for controlling the operation of one of the catalytic converters 30, 31, for example the converter 30 (with the understanding that this method is identical for the other converter 31).

when the computer 27 receives a diagnosis request from the converter 30, it uses the sensor 24 to measure the exhaust gas temperature upstream of the converter 30 and checks that this is equal to the ignition temperature of the converter 30 for a given set of running conditions.

If the measured temperature has not reached the ignition temperature of the converter 30, the computer activates the specific system for injecting fuel into the engine combustion chamber in order to raise it to this ignition temperature.

The computer 27 then excites the catalytic converter 30 by injecting or vaporizing a predefined quantity of fuel in the exhaust line E upstream of the converter 30. For this purpose, the computer 27 controls the injector 20 also supplied by the pump 28 (see FIG. 4A) or the pump 28 which supplies the vaporizer 22 via the fuel heating system 21 (see FIG. 4B).

FIG. 7 shows the variation, as a function of time, of the temperature upstream of a new converter (curve E), of the temperature downstream of a new converter (curve F), of the temperature upstream of an old converter (curve G) and of the temperature downstream of an old converter (curve H).

These curves show that the quantity of heat Q1 emitted by the chemical oxidation reaction in the converter as a result of the post-injection, for a new converter, is much higher than the quantity of heat Q2 emitted during the chemical oxidation reaction in an old converter.

Similarly, these curves show that the ignition time of a new converter occupied by a post-injection is much shorter than the ignition time of an old converter occupied by post-injection.

Thus, after having excited the catalytic converter 30, the computer 27 analyzes the ignition time of the converter 30 and the quantity of heat emitted by the reaction implemented in the converter 30, for example by comparison with a threshold value below which the converter is considered to be defective.

The computer 27 calculates the difference between the temperature downstream of the converter and the temperature upstream of the converter, and then compares the difference thus calculated with a threshold value for detecting a malfunction, reflecting the aging of the catalyst. If a malfunction is detected, it is indicated to the driver by turning on a light on the dashboard of the motor vehicle, or if not, the computer 27 cuts off the dedicated system 20 for post-injection in the exhaust line.

The threshold value used to control the satisfactory operation of the converter corresponds to a quantity of heat emitted by a converter whereof the aging, and hence the conversion capacity, is at the acceptability limit.

Similarly, the computer 27 calculates the temperature rise time of the converter 30 tested and compares it with a threshold temperature rise time of a converter at the acceptability limit. Either the temperature rise time is shorter than the given threshold and the converter is considered sound, or it is higher than this threshold and a converter malfunction is detected. Such a malfunction is then indicated to the driver by turning on a lamp on the dashboard of the motor vehicle. If no malfunction is detected, the computer 27 cuts off the dedicated system 20 for post-injection in the exhaust line.

As shown by the algorithm in FIG. 8, the tests of the quantity of heat and of the ignition time can be coupled by the computer 27 in order to improve the diagnosis of the converter concerned.

It may be noted in this connection that, preferably, the computer 27 comprises, stored in memory, a set of threshold values each associated with specific operating parameters of the engine.

Thus, to control the operating status of a converter, the computer 27 acquires the engine operating parameters, such as in particular, the engine speed, the pressure in the air intake circuit, etc., which are supplied by sensors with which the engine is equipped, in order to determine the operating conditions thereof, and then extracts from the storage one or more corresponding threshold values, in order to adapt the minimum level of the quantity of heat or of the permissible ignition time to the engine operating parameters.

It should also be noted that the computer 27 further comprises, stored in memory, a mapping in which are stored a set of values of fuel flow rate and post-injection phasing as a function of the engine operating parameters, in order to optimize the arrival of the hydrocarbons in the converter to be tested when it ignites.

Similarly, the fuel injection flow rate lies within a clearly defined range in order to avoid damaging the converter by excessive emission of heat.

To determine the moment at which the post-injection is required, the computer acquires the value of the exhaust gas temperature upstream of the converter and then compares this temperature with an ignition temperature of a new converter. Once this temperature is reached, it causes the post-injection. In this respect, it should be observed that the use of the specific injection system in the engine cylinders to increase the gas temperature upstream of the converter is optional and the computer may simply monitor this temperature until it reaches the target ignition temperature.

Furthermore, the sensor 24 for measuring the temperature upstream of the converter 30 is also optional.

In the case in which this sensor is nonexistent, in order to determine the moment when post-injection must be activated to control the operating status of the converter 30, the computer 27 may comprise, stored in memory, temperature values upstream of the converter as a function of the downstream temperature and as a function of the engine operating conditions.

The computer 27 may also comprise a thermal model of the exhaust gases and thereby calculate the upstream temperature from the operating parameters of the engine and/or the converter.

The present invention is not at all limited to the embodiments described and shown, but a person skilled in the art will be capable of providing any alternative according to his expertise.

1-10. (canceled)

11. A device for controlling an operating status of a catalytic converter of an exhaust line of an internal combustion engine, comprising:
means for determining a temperature upstream of the converter;
means for adding fuel to the engine exhaust line at a moment when the exhaust gas temperature upstream of the catalytic converter corresponds to an ignition temperature of a converter having a normal operation; and
means for controlling a quantity of heat emitted by a reaction generated in the catalytic converter as a result of the fuel addition,
wherein the means for adding comprises a dedicated fuel feed system placed in the engine exhaust line upstream of the catalytic converter to be controlled.

12. The control device as claimed in claim 11, wherein the dedicated fuel feed system includes an injection system.

13. The control device as claimed in claim 11, wherein the dedicated fuel feed system includes a vaporization system.

14. The control device as claimed in claim 11, further comprising a fuel injection system for injecting fuel into at least one engine cylinder to raise the exhaust gas temperature upstream of the catalytic converter to the ignition temperature thereof regardless of the motor vehicle running conditions, the fuel injection system being coupled with the dedicated fuel feed system.

15. The control device as claimed in claim 11, further comprising means for feeding fuel directly from the motor vehicle fuel tank to the dedicated feed system.

16. The control device as claimed in claim 11, wherein the means for determining the gas temperature upstream of the catalytic converter comprises means for measuring the gas temperature.

17. The control device as claimed in claim 11, wherein the means for determining the gas temperature upstream of the catalytic converter comprises means for measuring operating parameters of the engine and/or the catalytic converter and a thermal model of the exhaust gases suitable for determining the gas temperature upstream of the catalytic converter as a function of operating parameters of the engine and/or the converter.

18. The control device as claimed in claim 11, wherein the means for controlling the quantity of heat emitted by the reaction generated in the catalytic converter comprises means for measuring the exhaust gas temperature downstream of the converter and means for comparing the gas temperature downstream of the catalytic converter with a threshold value for detecting a malfunction.

19. The control device as claimed in claim 18, further comprising a computer for controlling an operation of the engine and for controlling an operation of the converter, the computer comprising comparison means and storage means in which are stored a set of threshold values each associated with one of the operating parameters of the engine and/or the catalytic converter and a set of values of the thermal ignition temperature of the catalytic converter as a function of the exhaust gas flow rate in the converter, the threshold value supplied to the comparison means being extracted from the storage means according to the measured operating parameters.

20. An internal combustion engine for a motor vehicle comprising:
an exhaust line including at least one catalytic converter; and
a device for controlling an operating status of the catalytic converter as claimed in claim 11.
